(19) United States
(12) Patent Application Publication
(10) Pub. No.: US 2026/0010330 A1
(43) Pub. Date: Jan. 8, 2026

(54) PROACTIVE STREAMING OF A FIRST APPLICATION BASED ON INTERFACING WITH A SECOND APPLICATION IN CONNECTED ELECTRONIC DEVICES

(71) Applicant: MOTOROLA MOBILITY LLC, WILMINGTON, DE (US)

(72) Inventors: AMIT KUMAR AGRAWAL, BANGALORE (IN); KRISHNAN RAGHAVAN, BANGALORE (IN)

(21) Appl. No.: 18/762,056

(22) Filed: Jul. 2, 2024

(51) Int. Cl. G06F 3/14; G06F 9/451; G06F 40/205; H04L 9/40

(52) U.S. Cl. CPC G06F 3/1454; G06F 9/451; G06F 40/205; H04L 63/08; H04L 2463/082

(57) ABSTRACT

An electronic device, a method and a computer program product for streaming at least one first application to a second electronic device. The method includes detecting, via at least one processor of a first electronic device, a trigger indicative of at least one second application or application process being initiated on a second electronic device. In response to detecting the trigger, the method includes identifying at least one first application for streaming to the second electronic device. In response to identifying the at least one first application, the method includes initiating the at least one first application on the first electronic device and streaming content of the at least one first application from the first electronic device to the second electronic device to trigger modification of a second display of the second electronic device to render first application content on the second display of the second electronic device.

### BACKGROUND

### 1. Technical Field

The present disclosure generally relates to electronic devices and in particular electronic devices that support streaming of applications with a second device.

### 2. Description of the Related Art

Electronic devices, such as mobile phones, tablets, and laptops, are widely used for video, voice, and text communication and for data transmission. Application streaming is a method of providing an application that is opened on a first electronic device for presentation and/or user interfacing on a display of a second connected electronic device. Application streaming can be used to deliver content received from a server to a device. Application streaming can be used for various purposes, such as gaming, live broadcasting, video conferencing, and social media.

### BRIEF DESCRIPTION OF THE DRAWINGS

The description of the illustrative embodiments can be read in conjunction with the accompanying figures. It will be appreciated that for simplicity and clarity of illustration, elements illustrated in the figures have not necessarily been drawn to scale. For example, the dimensions of some of the elements are exaggerated relative to other elements. Embodiments incorporating teachings of the present disclosure are shown and described with respect to the figures presented herein, in which:

FIG. 1 depicts an example electronic device within which various aspects of the disclosure can be implemented, according to one or more embodiments;

FIG. 2 is an example illustration of the electronic device of FIG. 1 in communication with a computer system and a second electronic device, according to one or more embodiments;

FIG. 3 is a block diagram of example contents of the system memory of the example electronic device of FIG. 1 configured to complete the various processes described herein, according to one or more embodiments;

FIG. 4A is a block diagram of example contents of historical application streaming data, according to one or more embodiments;

FIG. 4B is a block diagram of example contents of a manual application mapping, according to one or more embodiments;

FIG. 5 is an example illustration of a display of an electronic device presenting a graphical user interface (GUI) that includes example user-selectable options for streaming applications to another electronic device, according to one or more embodiments;

FIG. 6A is an example illustration of the example electronic device of FIG. 1, that is dynamically streaming application content to a second electronic device, according to one or more embodiments;

FIG. 6B is an example illustration of the example electronic device of FIG. 1, that is dynamically streaming application content, including a two factor authentication window, to a second electronic device, according to one or more embodiments;

FIG. 7 depicts a flowchart of a method by which an electronic device streams at least one application to a second electronic device in response to detecting a trigger indicative of at least one second application/process being initiated on the second electronic device, according to one or more embodiments; and

FIG. 8 depicts a flowchart of a method by which an electronic device streams at least one application to a second electronic device in response to receiving a message from a server computer system, according to one or more embodiments.

### DETAILED DESCRIPTION

According to one or more aspects of the disclosure, the illustrative embodiments provide an electronic device, a method, and a computer program product for dynamically streaming at least one first application to a second electronic device responsive to a detected trigger. In a first embodiment, a first electronic device includes a first display, a communications subsystem, a memory having stored thereon an application streaming module for streaming at least one first application to a second electronic device, and at least one processor communicatively coupled to the display, the communications subsystem, and the memory. The at least one processor executes program code of the application streaming module, and is configured to cause the first electronic device to detect a trigger indicative of at least one second application or process being initiated on the second electronic device, the second electronic device being communicatively coupled to the first electronic device via an application streaming session. In response to detecting the trigger, the at least one processor identifies at least one first application for streaming to the second electronic device, the at least one first application having an association with the at least one second application. In response to identifying the at least one first application, the at least one processor initiates the at least one first application on the first electronic device and streams content (e.g. graphical and information content) of the at least one first application from the first electronic device to the second electronic device to trigger modification of a second display of the second electronic device to render first application content on the second display of the second electronic device.

According to another embodiment, the method includes detecting, via at least one processor of a first electronic device, a trigger indicative of at least one second application or process being initiated on a second electronic device, the second electronic device being communicatively coupled to the first electronic device via a connection that supports an application streaming session. In response to detecting the trigger, the method includes identifying at least one first application for streaming to the second electronic device, the at least one first application having an association with the at least one second application. In response to identifying the at least one first application, the method includes initiating the at least one first application on the first electronic device and streaming content (e.g. graphical and information content) of the at least one first application from the first electronic device to the second electronic device to trigger modification of a second display of the second electronic device to render first application content on the second display of the second electronic device.

According to an additional embodiment, a computer program product includes a computer readable storage device having stored thereon program code that, when executed by at least one processor of a first electronic device having a display and a communications subsystem, the program code enables the first electronic device to complete the functionality of the above-described method processes.

The above contains simplifications, generalizations and omissions of detail and is not intended as a comprehensive description of the claimed subject matter but, rather, is intended to provide a brief overview of some of the functionality associated therewith. Other systems, methods, functionality, features, and advantages of the claimed subject matter will be or will become apparent to one with skill in the art upon examination of the figures and the remaining detailed written description. The above as well as additional objectives, features, and advantages of the present disclosure will become apparent in the following detailed description.

In the following description, specific example embodiments in which the disclosure may be practiced are described in sufficient detail to enable those skilled in the art to practice the disclosed embodiments. For example, specific details such as specific method orders, structures, elements, and connections have been presented herein. However, it is to be understood that the specific details presented need not be utilized to practice embodiments of the present disclosure. It is also to be understood that other embodiments may be utilized and that logical, architectural, programmatic, mechanical, electrical and other changes may be made without departing from the general scope of the disclosure. The following detailed description is, therefore, not to be taken in a limiting sense, and the scope of the present disclosure is defined by the appended claims and equivalents thereof.

References within the specification to “one embodiment,” “an embodiment,” “embodiments”, or “one or more embodiments” are intended to indicate that a particular feature, structure, or characteristic described in connection with the embodiment is included in at least one embodiment of the present disclosure. The appearance of such phrases in various places within the specification are not necessarily all referring to the same embodiment, nor are separate or alternative embodiments mutually exclusive of other embodiments. Further, various features are described which may be exhibited by some embodiments and not by others. Similarly, various aspects are described which may be aspects for some embodiments but not other embodiments.

The terminology used herein is for the purpose of describing particular embodiments only and is not intended to be limiting of the disclosure. As used herein, the singular forms “a”, “an”, and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Moreover, the use of the terms first, second, etc. do not denote any order or importance, but rather the terms first, second, etc. are used to distinguish one element from another.

It is understood that the use of specific component, device and/or parameter names and/or corresponding acronyms thereof, such as those of the executing utility, logic, and/or firmware described herein, are for example only and not meant to imply any limitations on the described embodiments. The embodiments may thus be described with different nomenclature and/or terminology utilized to describe the components, devices, parameters, methods and/or functions herein, without limitation. References to any specific protocol or proprietary name in describing one or more elements, features or concepts of the embodiments are provided solely as examples of one implementation, and such references do not limit the extension of the claimed embodiments to embodiments in which different element, feature, protocol, or concept names are utilized. Thus, each term utilized herein is to be provided its broadest interpretation given the context in which that term is utilized.

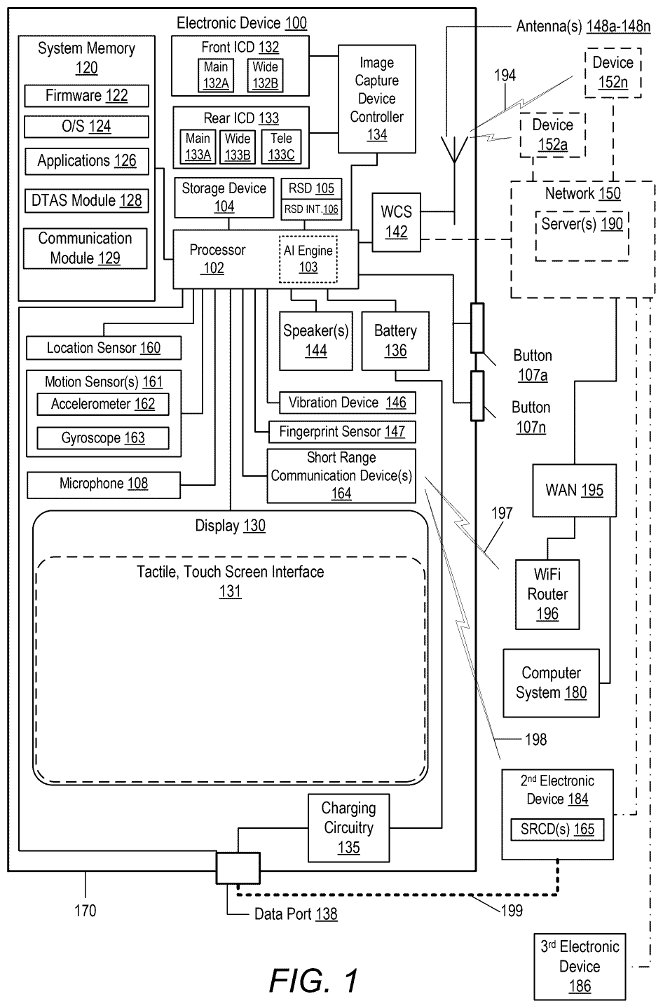

Those of ordinary skill in the art will appreciate that the hardware components and basic configuration depicted in the following figures may vary. For example, the illustrative components within electronic device 100 (FIG. 1) are not intended to be exhaustive, but rather are representative to highlight components that can be utilized to implement the present disclosure. For example, other devices/components may be used in addition to, or in place of, the hardware depicted. The depicted example is not meant to imply architectural or other limitations with respect to the presently described embodiments and/or the general disclosure.

Within the descriptions of the different views of the figures, the use of the same reference numerals and/or symbols in different drawings indicates similar or identical items, and similar elements can be provided similar names and reference numerals throughout the figure(s). The specific identifiers/names and reference numerals assigned to the elements are provided solely to aid in the description and are not meant to imply any limitations (structural or functional or otherwise) on the described embodiments.

FIG. 1 depicts an example electronic device 100 within which various aspects of the disclosure can be implemented, according to one or more embodiments. Examples of such electronic devices include, but are not limited to, mobile devices, a notebook computer, a mobile phone, a digital camera, a smart watch, a tablet computer, and a communication device, etc. It is appreciated that electronic device 100 can be other types of devices that include the capability to transmit and receive communications. Electronic device 100 includes processor 102, which is communicatively coupled to storage device 104, system memory 120, input devices, (introduced below), output devices, such as display 130, and image capture device (ICD) controller 134. In one or more embodiments, the functionality of ICD controller 134 is incorporated within processor 102, eliminating the need for a separate ICD controller. For simplicity in describing the features presented herein, the various camera control functions performed by the ICD controller 134 are described as being provided generally by processor 102. Processor 102 can include processor resources such as a primary processing unit (CPU) that support computing, classifying, processing and transmitting of data and information. Processor 102 can further include graphic processing units (GPU) and digital signal processors (DSP) that also support computing, classifying, processing and transmitting and receiving of data and information. Processor 102 can further include a hardware based artificial intelligence (AI) engine 103. AI engine 103 accelerates artificial intelligence, natural language processing (NLP), context evaluation (CE), and machine learning applications. AI engine 103 can also be implemented as a software module executed by processor 102, in one embodiment.

System memory 120 may be a combination of volatile and non-volatile memory, such as random access memory (RAM) and read-only memory (ROM). System memory 120 can store program code and data associated with firmware 122, an operating system 124, applications 126, dynamically triggered application streaming (DTAS) module 128, and communication module 129. Dynamically triggered application streaming module 128 includes program code that is executable by processor 102 to configure electronic device 100 to stream content of at least one application to another electronic device. Communication module 129 includes program code that is executed by processor 102 to enable electronic device 100 to communicate with other external devices and systems.

Although depicted as being separate from applications 126, dynamically triggered application streaming module 128 and communication module 129 may each be implemented as an application. Processor 102 loads and executes program code stored in system memory 120, including program code associated with applications 126 and program code associated with dynamically triggered application streaming module 128 and communication module 129. When processed/executed by processor 102, the program code causes or configures processor 102 and/or electronic device 100 to provide the various functionality described herein.

In one or more embodiments, electronic device includes removable storage device (RSD) 105, which is inserted into an RSD interface 106 that is communicatively coupled via system interlink to processor 102. In one or more embodiments, RSD 105 is a non-transitory computer program product or computer readable storage device. In one or more embodiments, RSD 105 is a computer readable storage device encoded with program code and corresponding data, and RSD 105 can interchangeably be referred to as a non-transitory computer program product. RSD 105 may have a version of dynamically triggered application streaming module 128 stored thereon, in addition to other program code. Processor 102 can access RSD 105 to provision electronic device 100 with program code that, when executed by processor 102, the program code causes or configures processor 102 and/or electronic device 100 to provide the functionality described herein.

Display 130 can be one of a wide variety of display screens or devices, such as a liquid crystal display (LCD) and an organic light emitting diode (OLED) display. In some embodiments, display 130 can be a touch screen device that can receive user tactile/touch input. As a touch screen device, display 130 includes a tactile, touch screen interface 131 that allows a user to provide input to or to control electronic device 100 by touching features presented within/below the display screen. Tactile, touch screen interface 131 can be utilized as an input device.

Throughout the disclosure, the term image capturing device is utilized interchangeably to be synonymous with and/or refer to any one of front or rear cameras 132, 133. As illustrated, electronic device 100 includes several front cameras 132. Electronic device 100 further includes several rear cameras 133. Each front camera 132A and 132B and each rear camera 133A, 133B and 133C is communicatively coupled to ICD controller 134, which is communicatively coupled to processor 102. ICD controller 134 supports the processing of signals from front cameras 132A and 132B and rear cameras 133A, 133B, and 133C.

Electronic device 100 can further include charging circuitry 135, battery 136, and data port 138, for providing electrical power to the various electronic components of electronic device 100. Electronic device 100 further includes microphone 108, one or more output devices such as speaker 144, and one or more input buttons 107a-n. Input buttons 107a-n may provide controls for volume, power, and/or image capture devices 132, 133. Microphone 108 can also be referred to as audio input device 108. Microphone 108 can be used to provide biometric data to identify or authenticate a user. Microphone 108 and input buttons 107a-n can also be referred to generally as input devices. Speaker 144 can provide an audio alert to a user.

Electronic device 100 further includes wireless communication subsystem (WCS) 142, which is coupled to antennas 148a-148n. In one or more embodiments, WCS 142 can include a communication module with one or more baseband processors or digital signal processors, one or more modems, and a radio frequency front end having one or more transmitters and one or more receivers. Wireless communication subsystem (WCS) 142 and antennas 148a-148n allow electronic device 100 to communicate wirelessly with wireless network 150 via transmissions of communication signals 194 to and from network communication devices 152a-152n, such as base stations or cellular nodes, of wireless network 150.

In one or more embodiment, wireless network 150 can include one or more servers 190 that support wireless exchange of voice, data, and video and other communication with electronic device 100. Wireless network 150 further allows electronic device 100 to communicate with computer system 180, second electronic device 184, and third electronic device 186. Computer system 180 is communicatively coupled to wireless network 150 by a wide area network (WAN) 195, such as the Internet. In an embodiment, servers 190 of wireless network 150 support wireless exchange of e-mail, text, data, and other communications between electronic device 100 and computer system 180. In one embodiment, computer system 180 can provide data, information, and resources to electronic device 100 for use with applications 126, and dynamically triggered application streaming module 128.

Second electronic device 184 and third electronic device 186 are also communicatively coupled to wireless network 150. Second electronic device 184 and third electronic device 186 can be similarly connected to wireless network 150, via one of network communication devices 152a-152n. In an embodiment, servers 190 of wireless network 150 support wireless exchange of voice, text, data, and video and other communication between electronic device 100 and second electronic device 184 and third electronic device 186. While electronic device 100 is shown in communication via wireless network 150 with two electronic devices 152a, 152n, electronic device 100 can be in communication with more or fewer than two electronic devices.

Electronic device 100 further includes short range communication device(s) 164. Short-range communication device(s) 164 includes one or more low powered transceiver(s) that can wirelessly communicate with other devices, such as second electronic device 184, via an established wireless connection 198. Second electronic device 184 includes short range communication device(s) (SRCD(s)) 165. Short-range communication device(s) 164 and 165 can wirelessly communicate with each other via wireless connection 198. Short-range communication device(s) 164 and 165 can include one or more of a variety of devices supporting different corresponding wireless protocols, such as a near field communication (NFC) device, a Bluetooth device, and/or a wireless fidelity (Wi-Fi) device. Electronic device 100 can also connect to second electronic device 184 using a wired connection 199 established via a USB or USB-c or other cabled connection via a data port 138. Electronic device 100 can also connect wirelessly to wireless network 150 via communication signals 197 transmitted by short-range communication device(s) 164 to and from WiFi router 196, which is communicatively coupled to WAN 195, such as the Internet, which, in turn, is communicatively coupled to wireless network 150.

Short-range communication device(s) 164 can wirelessly communicate with WiFi router 196 via communication signals 197. In one embodiment, electronic device 100 can receive Internet or Wi-Fi based calls via short-range communication device(s) 164. In one embodiment, electronic device 100 can communicate with WiFi router 196 wirelessly via short-range communication device(s) 164. In an embodiment, WCS 142, antennas 148a-148n and short-range communication device(s) 164 collectively provide communication interface(s) of a communications subsystem of electronic device 100.

Electronic device 100 further includes vibration device 146, fingerprint sensor 147, location sensor 160, and motion sensor(s) 161. Vibration device 146 can cause electronic device 100 to vibrate or shake when activated. Vibration device 146 can be activated to provide an alert or notification to a user of electronic device 100. According to one aspect of the disclosure, display 130, speakers 144, and vibration device 146 can generally and collectively be referred to as output devices. These output devices can be each utilized to present the different alerts to the user.

Fingerprint sensor 147 can be used to provide biometric data or images to identify or authenticate a user. Location sensor 160 can provide time data and location data about the physical location of electronic device 100. In one embodiment, location sensor 160 can be a global positioning system (GPS) device that uses data received from geospatial input received from GPS satellites.

Motion sensor(s) 161 can include one or more accelerometers 162 and gyroscope 163. Motion sensor(s) 161 can detect movement of electronic device 100 and provide motion data to processor 102 indicating the spatial orientation and movement of electronic device 100. Accelerometers 162 measure linear acceleration of movement of electronic device 100 in multiple axes (X, Y and Z). For example, accelerometers 162 can include three accelerometers, where one accelerometer measures linear acceleration in the X axis, one accelerometer measures linear acceleration in the Y axis, and one accelerometer measures linear acceleration in the Z axis. Gyroscope 163 measures rotation or angular rotational velocity of electronic device 100. Electronic device 100 further includes a housing 170 that contains the components of electronic device 100.

In the description of each of the following figures, reference is also made to specific components illustrated within the preceding figure. Similar or same components are presented with the same leading reference number.

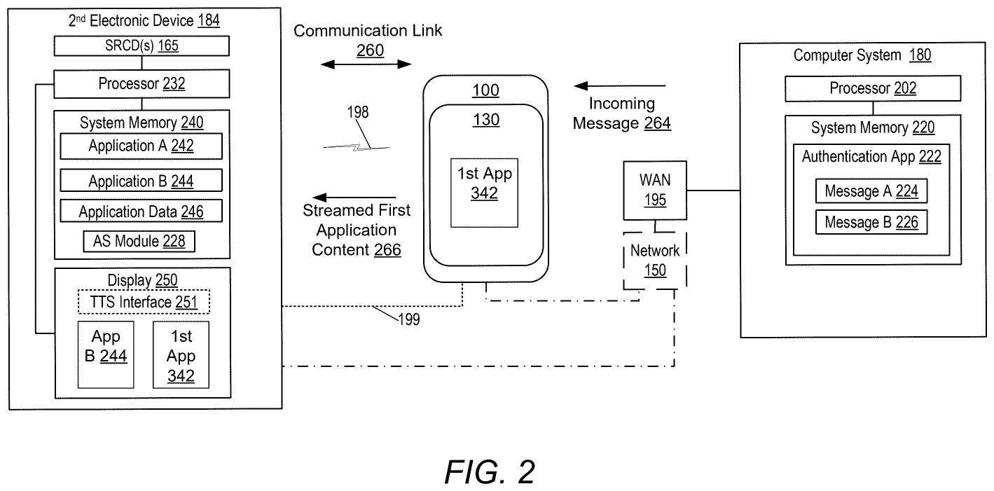

Turning to FIG. 2, with ongoing reference to FIG. 1, electronic device 100 is shown in communication with computer system 180, and second electronic device 184. Electronic device 100 can communicate wirelessly with second electronic device 184 via one or more of short-range communication device(s) 164 of electronic device 100 and short-range communication device 165 of second electronic device 184 (FIG. 1). Electronic device 100 can establish a streaming connection with second electronic device 184. The streaming connection can be a wireless connection 198 established via one or more of short-range communication device(s) 164 of electronic device 100 and short-range communication device 165 of second electronic device 184, in one embodiment. In another embodiment, the streaming connection can be a wired connection 199 established using a USB, micro-USB, USB-c or other cabled connection via data port 138 (FIG. 1). Electronic device 100 can also communicate wirelessly with computer system 180 via wireless network 150 via transmission and reception of communication signals 194 (FIG. 1). Communication network 150 includes communication servers 190 that are communicatively connected to a larger, wide area network (WAN) 195, such as the Internet. Electronic device 100 can also establish connection and communicate with wireless network 150 and with WAN 195 via WiFi router 196 and short-range communication device(s) 164 (FIG. 1).

Computer system 180 is communicatively coupled to a wide area network (WAN) 195, such as the Internet, to which server 190 of wireless network 150 is also communicatively coupled. In an embodiment, servers 190 of wireless network 150 support wireless exchange of e-mail, text, messages, data, and other communication between electronic device 100 and computer system 180, and second electronic device 184.

Computer system 180 can host one or more applications that provide various functions and/or processes. Computer system 180 includes processor 202, which is communicatively coupled to system memory 220. Processor 202 can include processor resources such as a primary processing unit (CPU) that support computing, classifying, processing and transmitting of data and information. Processor 202 can further include graphic processing units (GPU) and digital signal processors (DSP) that also support computing, classifying, processing and transmitting and receiving of data and information.

System memory 220 may be a combination of volatile and non-volatile memory, such as random access memory (RAM) and read-only memory (ROM). System memory 220 can store program code and data associated with authentication application (app) 222. Authentication application 222 provides secure access to websites or applications where a user is granted access after successfully presenting two or more pieces of evidence (i.e., two factor authentication) to an authentication mechanism. Authentication application 222 includes message A 224 and message B 226. In one embodiment, electronic device 100 can receive message A 224 from computer system 180. In response to receiving message A 224, electronic device 100 renders a corresponding first process for presentation on display 130 in order to facilitate two factor authentication.

Second electronic device 184 includes processor 232, which is communicatively coupled to system memory 240, short range communication device(s) (SRCD(s)) 165 and display 250. Processor 232 can include processor resources such as a primary processing unit (CPU) that support computing, classifying, processing and transmitting of data and information. Processor 232 can further include graphic processing units (GPU) and digital signal processors (DSP) that also support computing, classifying, processing and transmitting and receiving of data and information.

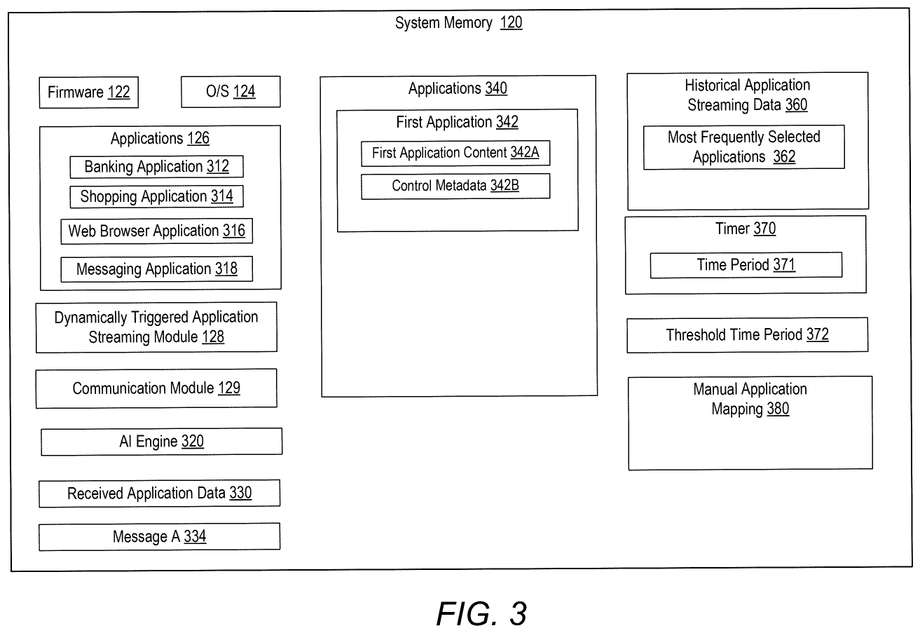

System memory 240 may be a combination of volatile and non-volatile memory, such as random access memory (RAM) and read-only memory (ROM). System memory 240 can store program code and data associated with application streaming module 228, application A 242, application B 244 and application data 246. Application streaming module 228 can present streamed contents of a graphical or video interface (e.g., streamed first application content 266) of at least one first application (e.g., first application 342 (FIG. 3)) received from electronic device 100. Application A 242 and application B 244 include program code that when processed/executed by processor 232, configures second electronic device 184 to provide various functions or processes. Application data 246 includes information and data about one or more applications of second electronic device 184 including information and data about application A 242 and application B 244.

One or both of applications A 242 or B 244 can provide or support functions that enable interfacing with processes performed at/on computer system 180 over a network 150. For example, application A 242 can be a web browser that is used to access a website on computer system 180. Processes occurring at the website can involve operations that serve as the trigger for causing the activation and streaming of a first application from electronic device to second electronic device. Thus, references herein to the second application and detection of activities involving a second application as being the trigger for the first device to stream the first application are understood to extend to use of the second application in such a context, where the actual trigger can be an activity or process that occurs on a different device, such as computer system 180. Somewhat similarly, references to dynamically streaming the first application can be extended to include processes performed by a first application, where the processes are being streamed for presentation on the second device display.

SRCD(s) 165 can wirelessly communicate with SRCD(s) 164 of electronic device 100 via wireless connection 198. In some embodiments, display 250 can be a touch screen device that can receive user tactile/touch input. As a touch screen device, display 250 includes a tactile, touch screen (TTS) interface 251 that allows a user to provide input to or to control second electronic device 184 by touching features presented within/below the display screen. Tactile, touch screen interface 251 can be utilized as an input device. Second electronic device 184 can also include other similar components that were previously described as included within the description of electronic device 100. Contents of application B 244 and received streamed first application contents 266 of first application 342 are shown being presented on display 250.

According to one aspect of the disclosure, electronic device 100 can detect establishing a communication link 260 with second electronic device 184. In response to establishing a communication link 260 with the second electronic device 184, electronic device 100 triggers the second electronic device 184 to transmit application data 246 corresponding to the at least one second application (e.g., application A 242) being initiated on the second electronic device 184. Electronic device 100 receives the application data 246 from the second electronic device 184 and determines, based on the received application data 246 corresponding to the at least one second application, if content (e.g., streamed first application content 266) of at least one first application (e.g., first app 342) that is likely to be or is being presented on electronic device 100 should be streamed to the second electronic device 184. The decision to stream the first application content 266 can be triggered by processes involving determining that the content of the first application is related to or being utilized by the content of the second application, such that concurrent/adjacent presentation of the content of the first application on the second display concurrently with presenting the second application adds efficiency and/or other benefits to the user.

According to another aspect of the disclosure, electronic device 100 can receive an incoming message 264 (e.g., message A 224) from computer system 180. In response to receiving the message, electronic device 100 renders a corresponding first process for presentation to a user. The corresponding first process is associated with the second application (e.g., application A 242) being initiated on the second electronic device 184. Electronic device 100 generates first application content for presentation on display 250 of the second electronic device 184. Electronic device 100 transmits the first application content, via a streaming interface (i.e., streamed first application content 266) created via the communications subsystem (i.e., SRCD(s) 164 and 165), with control metadata that prompts processor 232 of second electronic device 184 to modify a presented user interface of electronic device 100 with a rendering and presentation of the first application content on the second display 250.

Referring to FIG. 3, there is shown one embodiment of example contents of system memory 120 of electronic device 100 configured to complete the various processes described herein. System memory 120 includes data, software, and/or firmware modules, including firmware 122, an operating system (O/S) 124, applications 126, dynamically triggered application streaming (DTAS) module 128, and communication module 129.

Provided examples of applications 126 include banking application 312, shopping application 314, web browser application 316, and messaging application 318. Banking application 312 includes program code that is executed by processor 102 to configure electronic device 100 to access banking services provided by a bank or other financial institution, such as a credit card company, online payment service, etc. Shopping application 314 includes program code that is executed by processor 102 to configure electronic device 100 to access websites to browse and buy products or services from a retailer or service provider. Web browser application 316 includes program code that is executed by processor 102 to configure electronic device 100 to access various websites of the Internet. Messaging application 318 includes program code that is executed by processor 102 to configure electronic device 100 to send and receive messages, such as text or multi-media messages, with other electronic devices. While applications 126 are shown including four applications, applications 126 can include more or fewer than four applications.

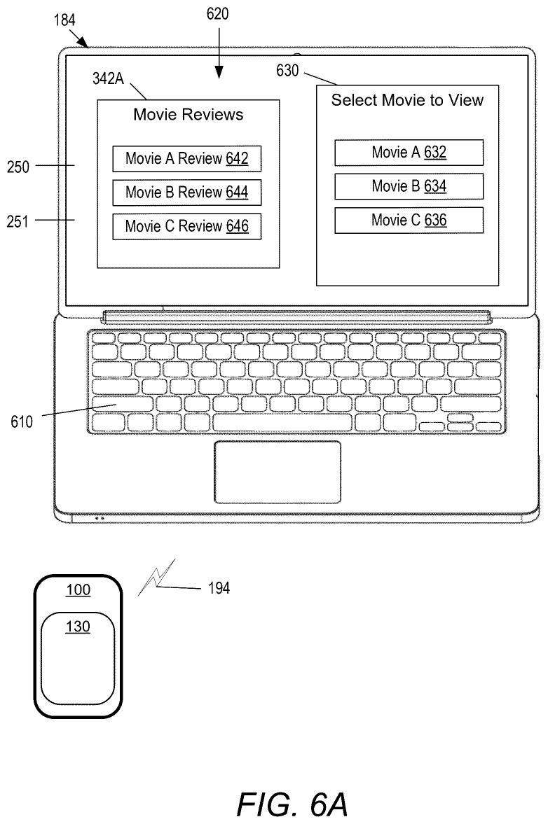

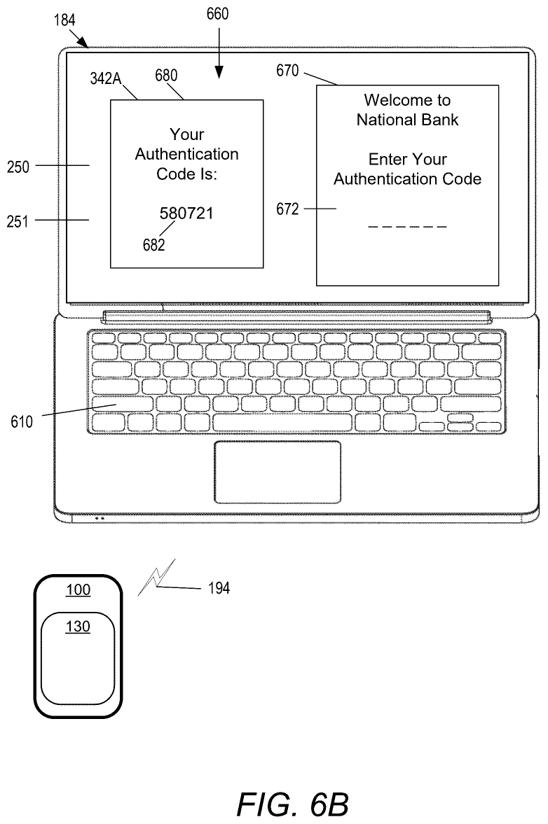

Dynamically triggered application streaming module 128 includes program code that is executed by processor 102, which configures electronic device 100 to perform the various features of the present disclosure. In one or more embodiments, dynamically triggered application streaming module 128 configures electronic device 100 to stream contents (e.g., streamed first application content 266) of a graphical or video interface of at least one first application to a second electronic device. In one or more embodiments, execution of dynamically triggered application streaming module 128 by processor 102 configures electronic device 100 to perform the processes presented in the flowcharts of FIGS. 6-8, as will be described below. Communication module 129 configures electronic device 100 to communicate and exchange data with other devices via SRCD(s) 164 and 165 and/or wireless network 150 and/or WiFi router 196. In one embodiment, communication module 129 can configure electronic device 100 to communicate and exchange data with other devices via a wired connection or interface 199, such as a universal serial bus (USB) cable. In another embodiment, communication module 129 can configure electronic device 100 to communicate and exchange data with other devices via a SRCD(s) 164 and WiFi router 196.

System memory 120 includes artificial intelligence (AI) engine 320. AI engine 320 accelerates artificial intelligence, natural language processing (NLP), context evaluation (CE), and machine learning applications.

System memory 120 includes received application data 330. Received application data 330 is received from another electronic device (e.g., second electronic device 184) or from another computer system 180, such as a server accessible via a network. Received application data 330 identifies one or more applications that correspond to at least one application that is being initiated or is running on the other electronic device (e.g., second electronic device 184).

System memory 120 includes message A 334, and applications 340. Message A 334 is a message or notification that is received from computer system 180. Applications 340 are applications that can be streamed to another electronic device. Applications 340 include first application 342. First application 342 includes first application content 342A and control metadata 342B. First application content 342A is content that is generated by the execution of first application 342 and can be streamed to another electronic device. Control metadata 342B can be used to control the presentation of first application content 342A on another electronic device.

As an example, first application 342 or an application process can be a notification surfacing application that can render and present one or more GUIs with data, textual prompts, and/or input entry areas for receipt of user input. First application 342 can be triggered by receipt of triggering information from computer system 180 or on detection and reporting of an activation of certain second applications on a second electronic device (e.g., second electronic device 184). As a specific example, first application 342 can generate and present a GUI with data for a 2FA that is received from a computer system 180, in response to access by a user at the second device 184 to a particular website or account using the second application. If access to the second application or to the website itself requires the 2FA, opening of the second application/accessing the website on the second electronic device 184 can then operate as the trigger received by the first electronic device 100 to complete the other described features of the disclosure

System memory 120 includes historical application streaming data 360. Historical application streaming data 360 includes the identity of corresponding applications that are initiated on electronic device 100 after a respective second application has been initiated on second electronic device 184. Historical application streaming data 360 includes a most frequently selected application 362 that is initiated on electronic device 100 after a respective second application has been initiated on second electronic device 184. A correlation of the two applications is thus created based on this historical trend, and the triggering of the first application 342 streaming is associated as an automatic response to future opening or activation of the second application (e.g., application A 242) on the second electronic device 184.

System memory 120 includes timer 370 and threshold time period 372. Timer 370 monitors a time period 371 between initiation of a second application (e.g., application A 242) on the second electronic device 184 and initiation of a first application (e.g., first application 342) on electronic device 100. Threshold time period 372 is a threshold length of time. When time period 371 tracked by timer 370 is less than the threshold time period 372, the first application 342 is automatically streamed from electronic device 100 to the second electronic device 184, after a second application (e.g., application A 242) has been initiated on the second electronic device 184.

System memory 120 includes manual application mapping 380. Manual application mapping 380 is a manual mapping that is set by a user and that maps the second application (e.g., application A 242) to a corresponding first application (e.g., first application 342) for streaming from electronic device 100 to the second electronic device 184.

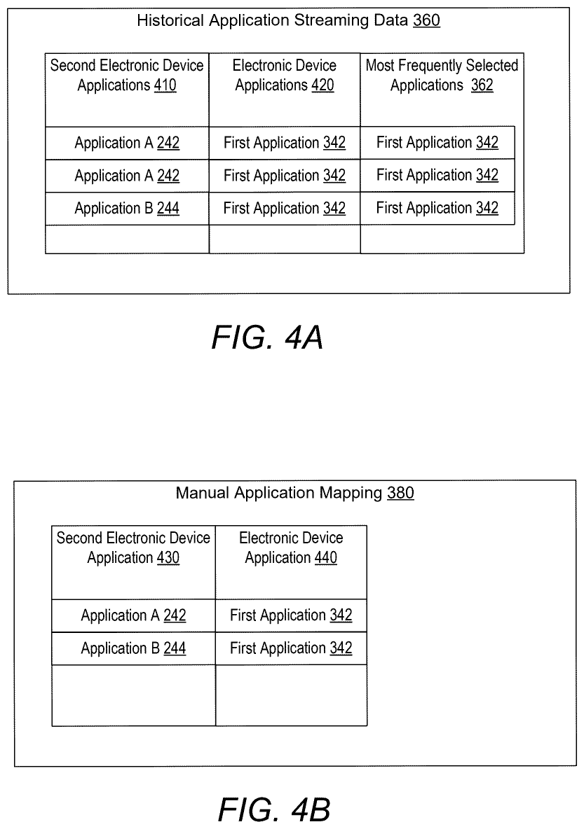

With reference to FIG. 4A, there is shown one embodiment of example contents of historical application streaming data 360 of system memory 120. Historical application streaming data 360 includes second electronic device applications 410, electronic device applications 420, and most frequently selected applications 362. Second electronic device applications 410 are a list of applications that have been initiated on second electronic device 184 over a period of time. In one embodiment, electronic device 100 can receive second electronic device applications 410 as part of received application data 330 from second electronic device 184. First electronic device applications 420 is a list of corresponding applications that have been initiated on electronic device 100 in response to detecting the initiation of at least one of second electronic device applications 410 on second electronic device 184. Most frequently selected applications 362 is the corresponding first electronic device application 420 that is most frequently initiated on electronic device 100 in response to detecting the initiation of a respective second electronic device application.

In one example embodiment, as shown in FIG. 4A, second electronic device application 410 can be application A 242, the corresponding electronic device application 420 can be first application 342, and the most frequently selected application 362 can be first application 342.

According to one aspect of the disclosure, to identify the at least one first application for streaming to the second electronic device 184, electronic device 100 retrieves historical application streaming data 360 for electronic device 100. Electronic device 100 parses the historical application streaming data 360 to find a most frequently selected application 362 that is initiated after the at least one second application 410 has been initiated on the second electronic device 184. Electronic device 100 identifies the most frequently selected application 362 as the at least one first application.

According to another aspect of the disclosure, to identify the at least one first application for streaming to the second electronic device 184, electronic device 100 monitors a time period 371 between initiation of the at least one second application 410 on the second electronic device 184 and initiation of the at least one first application on electronic device 100. In response to the time period 371 being less than a threshold time period 372, electronic device 100 automatically streams at least one first application as a corresponding application to the second electronic device 184 when the at least one second application 410 has been initiated on the second electronic device 184.

According to an additional aspect of the disclosure, to identify the at least one first application for streaming to the second electronic device 184, electronic device 100 retrieves historical application streaming data 360 for several electronic devices (i.e., electronic device 100 and electronic device 186). Electronic device 100 parses the historical application streaming data 360 to find a most frequently selected application 362 from among the plurality of electronic devices that is initiated after the at least one second application 410 has been initiated on the second electronic device 184. Electronic device 100 identifies the most frequently selected application 362 from among the plurality of electronic devices as the at least one first application.

With reference to FIG. 4B, there is shown one embodiment of example contents of manual application mapping 380 of system memory 120. Manual application mapping 380 can be pre-configured by a user of electronic device 100. Manual application mapping 380 maps the second application to a corresponding first application for streaming from electronic device 100 to the second electronic device 184 based on the manual setting. Manual application mapping 380 includes second electronic device applications 430 and corresponding electronic device applications 440.

Each second electronic device application 430 has a respective corresponding electronic device application 440. In one example embodiment, as shown in FIG. 4B, second electronic device application 410 can be application A 242, and the corresponding electronic device application 420 can be first application 342.

According to one aspect of the disclosure, to identify the at least one first application for streaming to the second electronic device 184, electronic device 100 determines if a manual setting (i.e., manual application mapping 380) that maps the at least one second application 430 to a corresponding at least one first application 440 has been selected. In response to determining that the manual setting has been selected, electronic device 100 identifies the at least one first application for streaming to the second electronic device based on the manual setting.

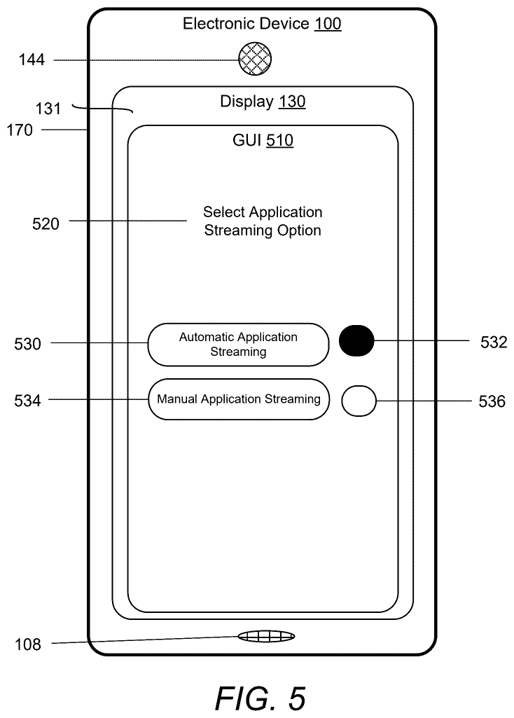

Referring to FIG. 5, electronic device 100 is shown with example streaming option (SO) graphical user interface (GUI) 510 presented on display 130. SO GUI 510 includes a description 520 of the purpose of SO GUI 510 and a listing of several potential application streaming options that a user can select to choose how applications are selected for streaming from electronic device 100. Specifically, SO GUI 510 includes automatic application streaming option 530, with option on/off indication 532, and manual application streaming option 534, with option on/off indication 536. In FIG. 5, automatic application streaming option 530 have been selected to automatically initiate application streaming with respective option on/off indication 532 filled in or checked.

According to one aspect of the disclosure, electronic device 100 can render SO GUI 510 on display 130. SO GUI 510 includes a user-selectable option 530 to automatically initiate streaming, to the second electronic device 184, of content (e.g., first application content 342A) of at least one local application (e.g., first application 342) that has an association with a second application (e.g., application A 342) that is executable on the communicatively-connected second electronic device 184. The at least one local application includes the at least one first application 342. In response to detecting selection of the user-selectable option 530, electronic device 100 initiates monitoring for the trigger indicative of the at least one second application (e.g., application A 342) being initiated on the second electronic device 184. Electronic device 100 automatically initiates streaming of content (e.g., first application content 342A) of the at least one first application (e.g., first application 342) to the second electronic device 184 when the trigger is detected.

Turning to FIG. 6A, second electronic device 184 is shown wirelessly receiving streaming application content from electronic device 100. In one embodiment, second electronic device 184 can be a laptop with a display 250 and a keyboard 610. Display 250 can include a tactile touch screen interface 251. Display 250 is shown displaying content originating from second electronic device 184 including a graphical user interface (GUI) 620 that contains application content 630 from application A 242. Application content 630 includes several movies that are selectable by a user for viewing on display 250. Application content 630 includes movie A 632, movie B 634, and movie C 636.

Display 250 is further shown displaying content originating from electronic device 100. Second electronic device 184 can wirelessly receive streaming application content from electronic device 100 via wireless communication signals 198. GUI 620 further includes first application content 342A streamed from first application 342 that is executing on electronic device 100. In one embodiment, first application 342 can be a movie review application. A user may desire to view movie reviews from first application 342 at the same time while deciding which movie to view from application A 242. First application content 342A includes several movie reviews that are selectable by a user for viewing on display 250. Specifically, first application content 342A includes movie A review 642, movie B review 644, and movie C review 646.

According to one aspect of the disclosure, electronic device 100 can detect a trigger indicative of at least one second application (e.g., application A 242) being initiated on the second electronic device 184. In response to detecting the trigger, electronic device 100 identifies at least one first application 342 for streaming to the second electronic device 184. In response to identifying the at least one first application 342, electronic device 100 initiates the at least one first application 342 on electronic device 100. Electronic device 100 streams first application content 342A and control metadata 342B of the at least one first application 342 from electronic device 100 to the second electronic device 184 to trigger modification of second display 250 of the second electronic device 184 to render first application content 342A on the second display 250 of the second electronic device 184.

According to another aspect of the disclosure, to detect the trigger, electronic device 100 detects communication link 260 with second electronic device 184. In response to detecting communication link 260 with second electronic device 184, electronic device 100 triggers second electronic device 184 to transmit application data 246 corresponding to the at least one second application (e.g., application A 242) being initiated on the second electronic device 184. Electronic device 100 receives the application data 246 from the second electronic device 184. Electronic device 100 determines if content of the at least one first application 342 is to be streamed to the second electronic device 184 based on the received application data 246 corresponding to the at least one second application (e.g., application A 242).

Turning to FIG. 6B, second electronic device 184 is shown wirelessly receiving streaming application content from electronic device 100. In one embodiment, second electronic device 184 can be a laptop with a display 250 and a keyboard 610. Display 250 can include a tactile touch screen interface 251. Display 250 is shown displaying content originating from second electronic device 184 including a graphical user interface (GUI) 660 that contains application content 670 from application B 244. In one embodiment, application B 244 can be a banking application. Application content 670 includes a login window 672 to enter an authentication code to complete a login to the banking application. In one embodiment, the banking application can use two factor authentication.

Display 250 is further shown displaying content originating from electronic device 100. Second electronic device 184 can wirelessly receive streaming application content from electronic device 100 via wireless communication signals 198. GUI 660 further includes first application content 342A streamed from first application 342 that is executing on electronic device 100. In one embodiment, first application 342 can be a two-factor authentication application that is part of part of a two-factor authentication (2FA) process. Accordingly, with this embodiment, GUI 660 further includes a 2FA window 680 with an authentication code 682 than can be used to complete an authentication process. In one embodiment, authentication code 682 can be presented by itself.

According to one aspect of the disclosure, electronic device 100 can detect a trigger indicative of at least one second application (e.g., application B 244) being initiated on the second electronic device 184. The trigger is message A 224 received from computer system 180 and causes processor 102 to render a corresponding first process for presentation to the user. The corresponding first process is associated with the second application (e.g., application B 244) being initiated on second electronic device 184. Electronic device 100 receives message A 224 from computer system 180 and generates, in response to receiving the message, the first application content 342A for presentation on display 250 of second electronic device 184. Electronic device 100 transmits the first application content 342A, via a streaming interface created via the communications subsystem (i.e., SRCD(s) 164 and 165) with control metadata 342B that prompts a second processor 232 of the second electronic device 184 to present GUI 660 with the first application content 342A on the second display 250.

According to an additional aspect of the disclosure, the first process is a two-factor authentication (2FA) process and the first application content 342A includes a two-factor authentication window 680 that is rendered on display 250 of the second electronic device 184 concurrently with the at least one second application (e.g., application B 244) being initiated on the second electronic device 184.

According to another aspect of the disclosure, at least one of (i) a notification setting to transmit at least one notification from the first electronic device 100 to the second electronic device 184 is disabled, and (ii) and a notification setting to transmit at least one notification associated with a messaging application 318 from the first electronic device to the second electronic device is disabled. Electronic device 100 can identify the corresponding first process as a two-factor authentication (2FA) process providing a challenge question and a corresponding challenge answer for presentation to the user. The 2FA process with the first application content being a 2FA window comprising a 2FA challenge is rendered on the second display 250 of the second electronic device 184. In response to identifying that the notification process is disabled that prevents an expected 2FA notification with a challenge answer from being automatically presented on the second electronic device 184, electronic device 100 dynamically activates the streaming interface (e.g., communication link 260) and in response to receiving the 2FA notification, streams, via the streaming interface, a 2FA notification window 680 with the challenge answer 682 (i.e., passcode) to be outputted at the second electronic device 184.

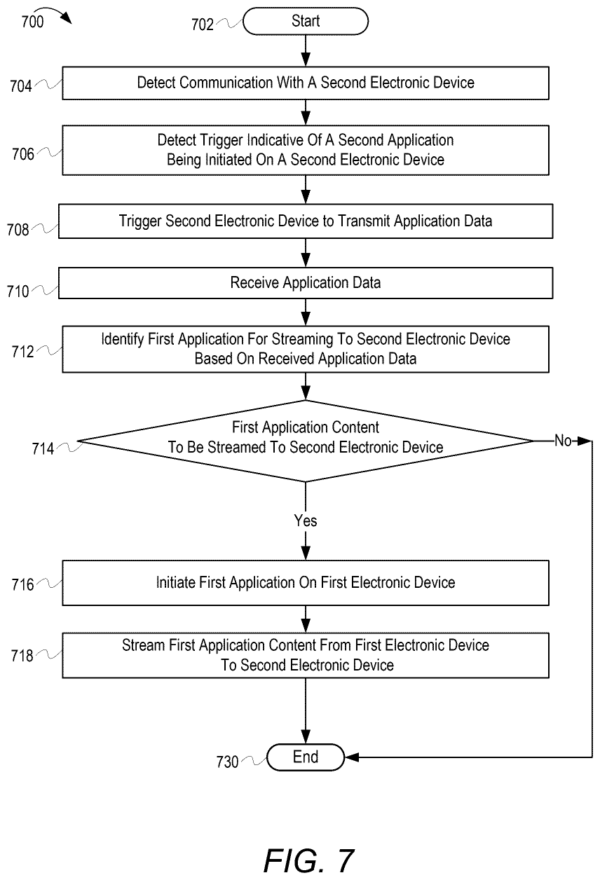

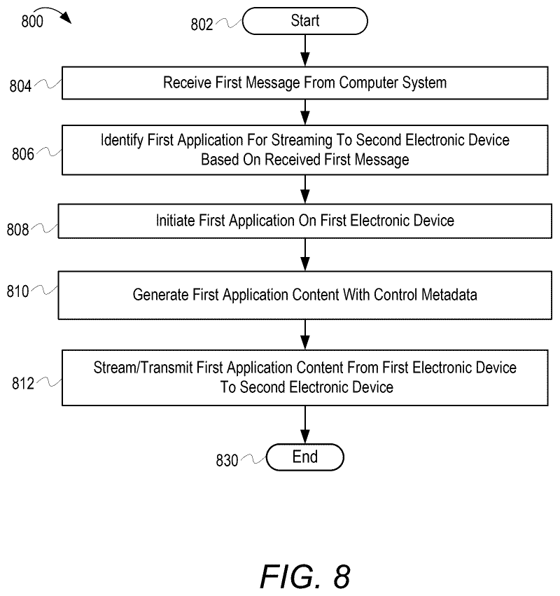

FIG. 7 depicts method 700 by which electronic device 100 streams at least one application to a second electronic device in response to detecting a trigger indicative of at least one second application being initiated on the second electronic device. FIG. 8 depicts method 800 by which electronic device 100 streams at least one application to a second electronic device in response to detecting a trigger from a computer system.

The description of methods 700 and 800 will be described with reference to the components and examples of FIGS. 1-6B. The operations depicted in FIGS. 7 and 8 can be performed by electronic device 100 or any suitable electronic device that includes the one or more functional components of electronic device 100 that provide/enable the described features. One or more of the processes of the methods described in FIGS. 7 and 8 may be performed by processor 102 executing program code associated with dynamically triggered application streaming module 128 and configuring the electronic device to perform the various processes.

With specific reference to FIG. 7 method 700 begins at the start block 702. At block 704, method 700 includes detecting communication link 260 with the second electronic device 184. In one embodiment, communication link 260 is enabled via a streaming interface created via a communications subsystem including SRCD(s) 164 and SRCD(s) 165. Method 700 includes detecting a trigger indicative of at least one second application (e.g., application A 242) being initiated or processes being performed with/within the at least one second application on the second electronic device 184 (block 706). In response to detecting the trigger, method 700 includes triggering the second electronic device 184 to transmit application data 246 corresponding to the at least one second application (e.g., application A 242) being initiated or the processes being performed with/within the at least one second application or on the second electronic device 184 (block 708). Method 700 includes receiving the application data 246 from the second electronic device (block 710). Method 700 includes identifying at least one first application 342 or process for streaming to the second electronic device 184 based on the received application data 246 (block 712).

At decision block 714, method 700 determines if first application content 342A of the at least one first application 342 is to be streamed to the second electronic device 184 based on the received application data 246 corresponding to the at least one second application or application process (e.g., application A 242). In response to determining that the first application content 342A of the at least one first application 342 is not to be streamed to the second electronic device 184, method 700 ends at end block 730. In response to determining that the first application content 342A of the at least one first application 342 is to be streamed to the second electronic device 184, method 700 includes initiating the at least one first application 342 on electronic device 100 (block 716). Method 700 includes streaming first application content 342A and control metadata 342B of the at least one first application 342 from electronic device 100 to the second electronic device 184 to trigger modification of second display 250 of the second electronic device 184 to render first application content 342A on the second display 250 of the second electronic device 184 (block 718). Method 700 ends at end block 730.

FIG. 8 depicts method 800 by which electronic device 100 streams at least one application to a second electronic device in response to receiving a message from a computer system. With reference to FIG. 8 method 800 begins at the start block 802. At block 804, method 800 includes receiving first message A 224 from computer system 180. Method 800 includes identifying at least one first application 342 or application content/processes for streaming to the second electronic device 184 based on the received first message A 224 (block 806).

Method 800 includes initiating the at least one first application 342 on electronic device 100 (block 808). Method 800 includes generating first application content 342A and control metadata 342B of the at least one first application 342 (block 810). In one embodiment, first application content 342A can include at least part or all of message A 224. In an example embodiment, message A 224 can be part of a two-factor authentication process and include an authentication code 682. The generated first application content 342A can include the authentication code 682. Method 800 includes streaming/transmitting the first application content 342A and control metadata 342B of the at least one first application 342 from electronic device 100 to the second electronic device 184 to trigger modification of second display 250 of the second electronic device 184 to render first application content 342A on the second display 250 of the second electronic device 184 (block 812). With the 2FA embodiment, rendering the first application content 342A on the second display 250 includes presenting/surfacing of authentication code 682. Method 800 ends at end block 830.

In the above-described methods of FIGS. 7 and 8, one or more of the method processes may be embodied in a computer readable device containing computer readable code such that operations are performed when the computer readable code is executed on a computing device. In some implementations, certain operations of the methods may be combined, performed simultaneously, in a different order, or omitted, without deviating from the scope of the disclosure. Further, additional operations may be performed, including operations described in other methods. Thus, while the method operations are described and illustrated in a particular sequence, use of a specific sequence or operations is not meant to imply any limitations on the disclosure. Changes may be made with regards to the sequence of operations without departing from the spirit or scope of the present disclosure. Use of a particular sequence is therefore, not to be taken in a limiting sense, and the scope of the present disclosure is defined only by the appended claims.

Aspects of the present disclosure are described above with reference to flowchart illustrations and/or block diagrams of methods, apparatus (systems) and computer program products according to embodiments of the disclosure. It will be understood that each block of the flowchart illustrations and/or block diagrams, and combinations of blocks in the flowchart illustrations and/or block diagrams, can be implemented by computer program instructions. Computer program code for carrying out operations for aspects of the present disclosure may be written in any combination of one or more programming languages, including an object-oriented programming language, without limitation. These computer program instructions may be provided to a processor of a general-purpose computer, special-purpose computer, or other programmable data processing apparatus to produce a machine that performs the method for implementing the functions/acts specified in the flowchart and/or block diagram block or blocks. The methods are implemented when the instructions are executed via the processor of the computer or other programmable data processing apparatus.

As will be further appreciated, the processes in embodiments of the present disclosure may be implemented using any combination of software, firmware, or hardware. Accordingly, aspects of the present disclosure may take the form of an entirely hardware embodiment or an embodiment combining software (including firmware, resident software, micro-code, etc.) and hardware aspects that may all generally be referred to herein as a “circuit,” “module,” or “system.” Furthermore, aspects of the present disclosure may take the form of a computer program product embodied in one or more computer readable storage device(s) having computer readable program code embodied thereon. Any combination of one or more computer readable storage device(s) may be utilized. The computer readable storage device may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage device can include the following: a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage device may be any tangible medium that can contain or store a program for use by or in connection with an instruction execution system, apparatus, or device.

Where utilized herein, the terms “tangible” and “non-transitory” are intended to describe a computer-readable storage medium (or “memory”) excluding propagating electromagnetic signals; but are not intended to otherwise limit the type of physical computer-readable storage device that is encompassed by the phrase “computer-readable medium” or memory. For instance, the terms “non-transitory computer readable medium” or “tangible memory” are intended to encompass types of storage devices that do not necessarily store information permanently, including, for example, RAM. Program instructions and data stored on a tangible computer-accessible storage medium in non-transitory form may afterwards be transmitted by transmission media or signals such as electrical, electromagnetic, or digital signals, which may be conveyed via a communication medium such as a network and/or a wireless link.

The description of the present disclosure has been presented for purposes of illustration and description, but is not intended to be exhaustive or limited to the disclosure in the form disclosed. Many modifications and variations will be apparent to those of ordinary skill in the art without departing from the scope of the disclosure. The described embodiments were chosen and described in order to best explain the principles of the disclosure and the practical application, and to enable others of ordinary skill in the art to understand the disclosure for various embodiments with various modifications as are suited to the particular use contemplated.

As used herein, the term “or” is inclusive unless otherwise explicitly noted. Thus, the phrase “at least one of A, B, or C” is satisfied by any element from the set {A, B, C} or any combination thereof, including multiples of any element.

While the disclosure has been described with reference to example embodiments, it will be understood by those skilled in the art that various changes may be made and equivalents may be substituted for elements thereof without departing from the scope of the disclosure. In addition, many modifications may be made to adapt a particular system, device, or component thereof to the teachings of the disclosure without departing from the scope thereof. Therefore, it is intended that the disclosure not be limited to the particular embodiments disclosed for carrying out this disclosure, but that the disclosure will include all embodiments falling within the scope of the appended claims.

1. A first electronic device comprising:
a first display;
a communications subsystem that communicatively couples the first electronic device to a second electronic device during an app streaming session via a streaming interface;
a memory having stored thereon an application streaming module for streaming at least one first application to the second electronic device; and
at least one processor communicatively coupled to the first display, the communications subsystem, and the memory, the at least one processor executing program code of the application streaming module, the at least one processor configured to cause the first electronic device to:
detect a trigger indicative of at least one second application being initiated on the second electronic device;
in response to detecting the trigger, identify at least one first application for streaming to the second electronic device, the at least one first application associated with execution of the at least one second application; and
in response to identifying the at least one first application associated with the execution of the at least one second application:
initiate the at least one first application on the first electronic device; and
stream, via the communications subsystem, content of the at least one first application from the first electronic device to the second electronic device to trigger modification of a second display of the second electronic device to render first application content on the second display of the second electronic device.

2. The first electronic device of claim 1, wherein to detect the trigger, the at least one processor:
detects a communication link with the second electronic device;
in response to detecting the communication link with the second electronic device, triggers the second electronic device to transmit application data corresponding to the at least one second application being initiated on the second electronic device;
receives the application data from the second electronic device; and
determines, if content of the at least one first application is to be streamed to the second electronic device, based on the received application data corresponding to the at least one second application.

3. The first electronic device of claim 1, wherein:
the trigger comprises a first message received from a first computer system and which causes the at least one processor to render a corresponding first process for presentation to a user, the corresponding first process associated with the second application being initiated on the second electronic device; and
the at least one processor:
receives the first message from the first computer system;
generates, in response to receiving the first message, the first application content for presentation on the display of the second electronic device; and
transmits, via a streaming interface created using the communications subsystem, the first application content with control metadata that prompts a second processor of the second electronic device to modify a presented user interface of the first electronic device with the first application content on the second display.

4. The first electronic device of claim 3, wherein the corresponding first process is a two-factor authentication (2FA) process and the first application content is a 2FA window that is rendered on the second display of the second electronic device concurrently with the at least one second application being initiated on the second electronic device.

5. The first electronic device of claim 3, wherein at least one of (i) a notification setting to transmit at least one notification from the first electronic device to the second electronic device is disabled, and (ii) and a notification setting to transmit at least one notification associated with a messaging application from the first electronic device to the second electronic device is disabled, and the at least one processor:
identifies the corresponding first process as a two-factor authentication (2FA) process with the first application content being a 2FA window comprising a 2FA challenge that is rendered on the second display of the second electronic device; and
in response to identifying that the notification setting is disabled that prevents an expected 2FA notification with a challenge answer from being automatically presented on the second electronic device:
dynamically activates the streaming interface; and
in response to receiving the 2FA notification, streams, via the streaming interface, a 2FA notification window with the challenge answer to be outputted at the second electronic device.

6. The first electronic device of claim 1, wherein the at least one processor:
renders a first graphical user interface (GUI) on the first display, the first GUI including a first user-selectable option to automatically initiate streaming, to the second electronic device, of content of at least one local application that has an association with the second application which is initiated on the communicatively-connected second electronic device, the at least one local application comprising the at least one first application; and
in response to detecting selection of the first user-selectable option:
initiates monitoring for the trigger indicative of the at least one second application being initiated on the second electronic device; and
automatically initiates streaming of content of the at least one first application to the second electronic device when the trigger is detected.

7. The first electronic device of claim 1, wherein:
to identify the at least one first application for streaming to the second electronic device, the at least one processor:
retrieves historical application streaming data for the first electronic device;
parses the historical application streaming data for the first electronic device to find a most frequently selected application that is initiated after the at least one second application has been initiated on the second electronic device; and
identifies the most frequently selected application as the at least one first application.

8. The first electronic device of claim 1, wherein:
to identify the at least one first application for streaming to the second electronic device, the at least one processor:
monitors a time period between initiation of the at least one second application on the second electronic device and initiation of the at least one first application on the first electronic device; and
in response to the time period being less than a threshold time period, automatically streams the at least one first application as a corresponding application to the second electronic device when the at least one second application has been initiated on the second electronic device.

9. The first electronic device of claim 1, wherein:
to identify the at least one first application for streaming to the second electronic device, the at least one processor:
retrieves historical application streaming data for a plurality of electronic devices;
parses the historical application streaming data to find a most frequently selected application from among the plurality of electronic devices that is initiated after the at least one second application has been initiated on the second electronic device; and
identifies, as the at least one first application, the most frequently selected application from among the plurality of electronic devices.

10. The first electronic device of claim 1, wherein:
to identify the at least one first application for streaming to the second electronic device, the at least one processor:
determines if a manual setting that maps the at least one second application to a corresponding at least one first application has been selected; and
in response to determining that the manual setting has been selected, identifies the at least one first application for streaming to the second electronic device based on the manual setting.

11. A method comprising:
detecting, via at least one processor of a first electronic device, a trigger indicative of at least one second application or application process being initiated on a second electronic device;
in response to detecting the trigger, identifying at least one first application or first application process for streaming to the second electronic device, the at least one first application or first application process associated with execution of the at least one second application or application process; and
in response to identifying the at least one first application or first application process:
initiating the at least one first application on the first electronic device; and
streaming content of the at least one first application or first application process from the first electronic device to the second electronic device to trigger modification of a second display of the second electronic device to render first application content on the second display of the second electronic device.

12. The method of claim 11, wherein to detect the trigger, the method further comprises:
detecting a communication link with the second electronic device;
in response to detecting the communication link with the second electronic device, triggering the second electronic device to transmit application data corresponding to the at least one second application being initiated on the second electronic device;
receiving the application data from the second electronic device; and
determining, if content of the at least one first application is to be streamed to the second electronic device based on the received application data corresponding to the at least one second application.

13. The method of claim 11, wherein:
the trigger comprises a first message received from a first computer system and which causes the at least one processor to render a corresponding first process for presentation to a user, the corresponding first process associated with the second application being initiated on the second electronic device; and
the method further comprises:
receiving the first message from the first computer system;
generating, in response to receiving the first message, the first application content for presentation on the display of the second electronic device; and
transmitting, via a streaming interface created via a communications subsystem, the first application content with control metadata that prompts a second processor of the second electronic device to modify a presented user interface of the first electronic device with the first application content on the second display.

14. The method of claim 13, wherein the corresponding first process is a two-factor authentication (2FA) process and the first application content is a 2FA window that is rendered on the second display of the second electronic device concurrently with the at least one second application being initiated on the second electronic device.

15. The method of claim 11, further comprising:
rendering a first graphical user interface (GUI) on the first display, the first GUI including a first user-selectable option to automatically initiate streaming, to the second electronic device, of content of at least one local application that has an association with the second application which is initiated on the communicatively-connected second electronic device, the at least one local application comprising the at least one first application; and
in response to detecting selection of the first user-selectable option:
initiating monitoring for the trigger indicative of the at least one second application being initiated on the second electronic device; and
automatically initiating streaming of content of the at least one first application to the second electronic device when the trigger is detected.

16. The method of claim 11, wherein:
to identify the at least one first application for streaming to the second electronic device, the method further comprises:
retrieving historical application streaming data for the first electronic device;
parsing the historical application streaming data for the first electronic device to find a most frequently selected application that is initiated after the at least one second application has been initiated on the second electronic device; and
identifying the most frequently selected application as the at least one first application.

17. The method of claim 11, wherein:
to identify the at least one first application for streaming to the second electronic device, the method further comprises:
monitoring a time period between initiation of the at least one second application on the second electronic device and initiation of the at least one first application on the first electronic device; and
in response to the time period being less than a threshold time period, automatically streaming the at least one first application as a corresponding application to the second electronic device when the at least one second application has been initiated on the second electronic device.

18. The method of claim 11, wherein:
to identify the at least one first application for streaming to the second electronic device, the method further comprises:
retrieving historical application streaming data for a plurality of electronic devices;
parsing the historical application streaming data to find a most frequently selected application from among the plurality of electronic devices that is initiated after the at least one second application has been initiated on the second electronic device; and
identifying, as the at least one first application, the most frequently selected application from among the plurality of electronic devices as the at least one first application.

19. A computer program product comprising:
a non-transitory computer readable storage device having stored thereon program code which, when executed by at least one processor of a first electronic device having a first display and a communications subsystem configures the first electronic device to complete the functionality of:
detecting a trigger indicative of at least one second application being initiated on a second electronic device;
in response to detecting the trigger, identifying at least one first application for streaming to the second electronic device; and
in response to identifying the at least one first application:
initiating the at least one first application on the first electronic device; and
streaming content, via the communications subsystem, of the at least one first application from the first electronic device to the second electronic device to trigger modification of a second display of the second electronic device to render first application content on the second display of the second electronic device.

20. The computer program product of claim 19, wherein to detect the trigger, the program code further comprises program code that configures the first electronic device to complete the functionality of:
detecting a communication link with the second electronic device;
in response to detecting the communication link with the second electronic device, triggering the second electronic device to transmit application data corresponding to the at least one second application being initiated on the second electronic device;
receiving the application data from the second electronic device; and
determining if content of the at least one first application is to be streamed to the second electronic device based on the received application data corresponding to the at least one second application.
